(19) United States
(12) Patent Application Publication
(10) Pub. No.: US 2013/0025368 A1
(43) Pub. Date: Jan. 31, 2013

(54) MICROELECTROMECHANICAL GYROSCOPE WITH IMPROVED READING STAGE AND METHOD

(71) Applicants: Andrea Donadel, Meda (IT); Andrea Visconti, Varese (IT)

(72) Inventors: Andrea Donadel, Meda (IT); Andrea Visconti, Varese (IT)

(73) Assignee: STMICROELECTRONICS S.R.L., Agrate Brianza (IT)

(21) Appl. No.: 13/558,266

(22) Filed: Jul. 25, 2012

(30) Foreign Application Priority Data
Jul. 28, 2011 (IT) TO2011A000685

(51) Int. Cl. G01C 19/567

(52) U.S. Cl. 73/504.12

(57) ABSTRACT

A gyroscope, including: a body; a driving mass, mobile along a driving axis; a driving device that keeps the driving mass in oscillation according to the driving axis at a driving frequency; a sensing mass, coupled to the driving mass to move according to the driving axis and is mobile with respect to the driving mass along a sensing axis; and a reading device, which receives a sensing signal associated with the movement of the sensing mass and supplies an output signal indicating a position of the sensing mass. The reading device includes an analog-to-digital converter, which receives a voltage signal associated with the sensing signal. The voltage signal includes a useful signal component and a spurious signal component, phase-shifted with respect to one another by approximately 90°, and the analog-to-digital converter is configured for sampling the voltage signal at maximum values assumed by the useful signal component.

### BACKGROUND

1. Technical Field

The present disclosure relates to a microelectromechanical gyroscope with an improved reading stage, and to a corresponding reading method.

2. Description of the Related Art

As is known, the use of microelectromechanical systems (MEMS) has become increasingly widespread in various sectors of technology and has yielded encouraging results especially in the production of inertial sensors, microintegrated gyroscopes, and electromechanical oscillators for a wide range of applications.

MEMS of this type are usually based upon microelectromechanical structures comprising at least one mobile mass connected to a fixed body (stator) by means of springs and mobile with respect to the stator according to pre-set degrees of freedom. The mobile mass is moreover coupled to the fixed body via capacitive structures (capacitors). The movement of the mobile mass with respect to the fixed body, for example on account of an external stress, modifies the capacitance of the capacitors, whence it is possible to trace back to the relative displacement of the mobile mass with respect to the fixed body and hence to the force applied. Conversely, by supplying appropriate biasing voltages, it is possible to apply an electrostatic force to the mobile mass to set it in motion. Furthermore, to obtain electromechanical oscillators the frequency response of the inertial MEMS structures is exploited, which is typically of a second-order lowpass type.

Many MEMS systems (in particular, all electromechanical oscillators and gyroscopes) must envisage driving devices that have the task of keeping the mobile mass in oscillation.

A first known type of solution envisages applying, in open loop, periodic stresses at the resonance frequency of the MEMS structure. The solution is simple, but also very far from effective, because the resonance frequency is not known precisely on account of the ineliminable dispersions in the processes of micromachining of semiconductors. Furthermore, the resonance frequency of each individual device can vary over time, for example on account of temperature gradients or, more simply, owing to ageing.

There have then been proposed feedback driving circuits, based upon the use of sigma-delta modulators. Circuits of this type are undoubtedly more effective than the previous ones in stabilizing the oscillation of the mobile mass at the real resonance frequency and in suppressing the disturbance. However, various stages are necessary for filtering, decimation and further processing of the bitstream supplied by the sigma-delta modulator. For this reason, currently available feedback driving circuits are complex to produce, cumbersome and, in practice, costly.

Furthermore, it should be considered that gyroscopes have a complex electromechanical structure, which comprises two masses that are mobile with respect to the stator and coupled together so as to have a relative degree of freedom. The two mobile masses are both capacitively coupled to the stator. One of the mobile masses is dedicated to driving (driving mass) and is kept in oscillation at the resonance frequency. The other mobile mass (sensing mass) is dragged along in oscillatory motion and, in the event of rotation of the microstructure with respect to a pre-set axis with an angular velocity, is subject to a Coriolis force proportional to the angular velocity itself. In practice, the sensing mass operates as an accelerometer that enables detection of the Coriolis force.

To enable actuation and produce an electromechanical oscillator where the sensor performs the role of selective frequency amplifier, with second-order transfer function of a lowpass type and high merit factor, the driving mass is equipped with two types of differential capacitive structures: driving electrodes and driving sensing electrodes. The driving electrodes have the purpose of sustaining the self-oscillation of the mobile mass in the direction of actuation. The driving sensing electrodes have the purpose of measuring, through the transduced charge, the position of translation or rotation of the sensing mass in the direction of actuation.

The patent No. EP 1 624 285, which corresponds to U.S. Pat. No. 7,305,880 describes a system for controlling the rate of oscillation of the gyroscope, comprising a reading system including a differential read amplifier, a highpass amplifier, and an driving-and-control stage, operating in a time-continuous way. All the components that form the reading system are of a discrete-time analog type and, in particular, are provided by means of fully differential switched-capacitor circuits.

The document No. EP 1 959 234, which corresponds to U.S. Pat. No. 7,827,864 describes an improvement of the previous control system, where the control loop comprises a filter having the purpose of reducing the offset and the effects of components and any parasitic coupling, operating on the overall gain and phase of the feedback loop.

FIG. 1 is a schematic illustration of a reading system for reading the signal generated at output by a gyroscope according to one embodiment of a known type. The reading system comprises a charge amplifier AMP_C, a demodulator DEM, a lowpass filter LPF, a sample-and-hold stage S&H, and an output amplifier AMP_O, cascaded together. The charge amplifier AMP_C and the demodulator DEM are of a fully differential switched-capacitor type. The charge amplifier AMP_C has inputs connected to the terminals of the sensing mass for receiving reading currents (or charge packets) correlated to the linear velocity of oscillation of the sensing mass. According to the operation of the charge amplifier AMP_C, present on its outputs are reading voltages indicating the displacement of the sensing mass. The signal supplied at output by the charge amplifier AMP_C is an amplitude-modulated signal.

The demodulator DEM receives the reading voltages supplied by the charge amplifier AMP_C and carries out, in a known way, a demodulation of the signal received. The output of the demodulator DEM is supplied to the filter LPF and, then, to the sample-and-hold stage S&H, which carries out a sample-and-hold function in a known way.

Reading systems according to known embodiments, which are of an analog type, entail a high use of area and high consumption levels, introduce noise, and do not enable a really efficient management of the signal at output from the gyroscope.

### BRIEF SUMMARY

The present disclosure is directed to a microelectromechanical gyroscope with an improved reading stage, and a corresponding reading method.

One embodiment is a microelectromechanical gyroscope that includes a body, a microelectromechanical control loop having a driving mass, mobile with respect to the body with a first degree of freedom according to a driving axis and a driving device coupled to the driving mass, the loop being configured to keep the driving mass in oscillation according to the driving axis at a driving frequency. The gyroscope includes a sensing mass, mechanically coupled to the driving mass and configured to move according to the driving axis, the sensing mass being mobile with respect to the driving mass with a second degree of freedom according to a sensing axis, in response to rotations of the body and a reading device having an input that is configured to receive a sensing signal associated with the movement of the sensing mass with respect to the driving axis and the sensing axis, the reading device being configured to supply an output signal that indicates a position of the sensing mass with respect to the driving axis and the sensing axis. The reading device includes an analog-to-digital converter having an input that is configured to receive a voltage signal associated with the sensing signal, said voltage signal having a first signal component and a spurious second signal component phase-shifted from the first signal component by approximately 90°, the analog-to-digital converter being configured to sample said voltage signal in correspondence with maximum values reached by the first signal component.

### BRIEF DESCRIPTION OF THE SEVERAL VIEWS OF THE DRAWINGS

For a better understanding of the disclosure, some embodiments thereof will now be described, purely by way of non-limiting example and with reference to the attached drawings, wherein:

FIG. 1 shows a reading circuit for a gyroscope according to one embodiment of a known type;

FIG. 2 is a simplified block diagram of a gyroscope;

FIG. 3 is a top plan view of a microstructure included in the gyroscope of FIG. 2;

FIG. 4 is a top plan view of a further microstructure of the gyroscope of FIG. 2;

FIG. 5 is a more detailed block diagram of the gyroscope of FIG. 2;

FIG. 6 is a block diagram of a reading circuit of the gyroscope of FIG. 2 and FIG. 5, according to one embodiment of the present disclosure;

FIGS. 7a and 7b are graphs representing plots of quantities regarding the reading circuit of FIG. 6; and

FIG. 8 is a simplified block diagram of an electronic system incorporating the gyroscope according to one embodiment of the present disclosure.

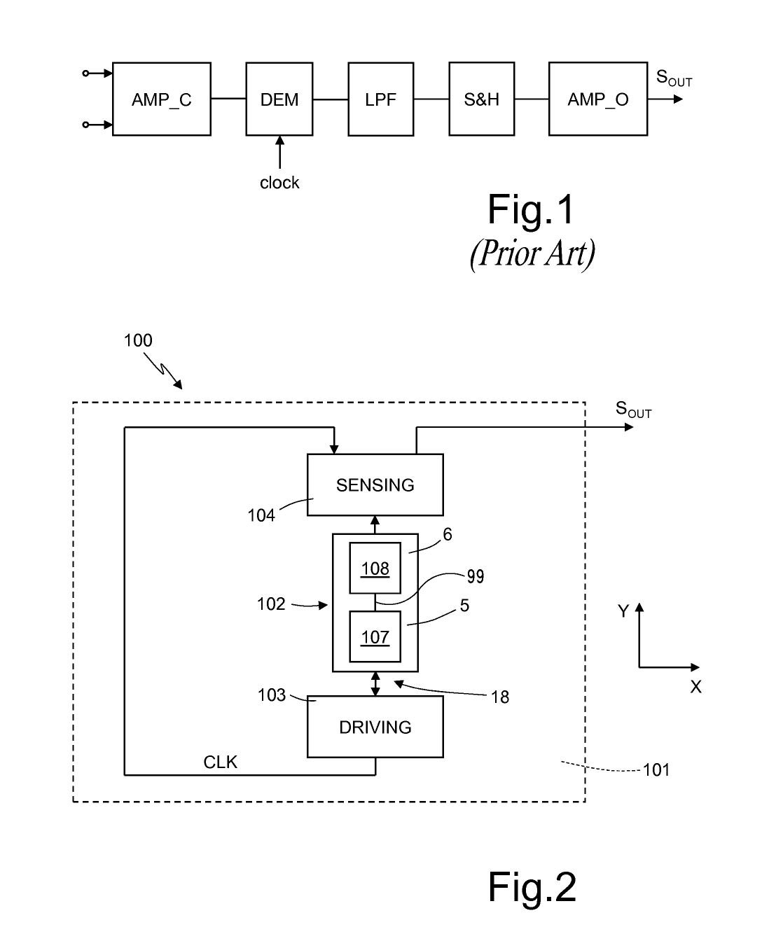

### DETAILED DESCRIPTION

FIG. 2 shows as a whole a microelectromechanical gyroscope 100, which comprises a microstructure 102, made of semiconductor material, a driving device 103, and a reading device 104.

The microstructure 102 is made of semiconductor material and comprises a fixed structure 6, a driving mass 107, and at least one sensing mass 108.

For reasons of simplicity, in the embodiment illustrated herein reference will be made to the case of a uniaxial gyroscope, present in which is just one sensing mass 108. What is described hereinafter applies, however, in the case of multiaxial gyroscopes, which comprise two or more masses or systems of sensing masses, for detection of rotations according to respective independent axes.

The driving mass 107 is elastically constrained to the fixed structure 6 so as to be able to oscillate about a resting position according to one translational or rotational degree of freedom. The sensing mass 108 is mechanically coupled to the driving mass 107 so as to be dragged along in motion according to the degree of freedom of the driving mass 107 itself. Furthermore, the sensing mass 108 is elastically constrained by elastic element 99 to the driving mass 107 so as to oscillate in turn with respect to the driving mass 107 itself, with a respective further degree of freedom.

In the embodiment described herein, in particular, the driving mass 107 is linearly mobile along a driving axis X, whereas the sensing mass 108 is mobile with respect to the driving mass 107 according to a sensing axis Y perpendicular to the driving axis X. It is understood, however, that the type of motion (translational or rotational) allowed by the degrees of freedom and the arrangement of the driving and sensing axes can vary according to the type of gyroscope. With reference to the movements of the driving mass 107 and of the sensing mass 108, moreover, the expression “according to an axis” will henceforth be indifferently used to indicate movements along an axis or about an axis, according to whether the movements allowed for the masses by the respective degrees of freedom are translational (along an axis) or else rotational (about an axis), respectively. Likewise, the expression “according to one degree of freedom” will be indifferently used to indicate translational or rotational movements, as allowed by said degree of freedom.

Furthermore, the driving mass 107 (with the sensing mass 108) is connected to the fixed structure 6 so as to define a resonant mechanical system with a resonance frequency ω_{R} (according to the driving axis X).

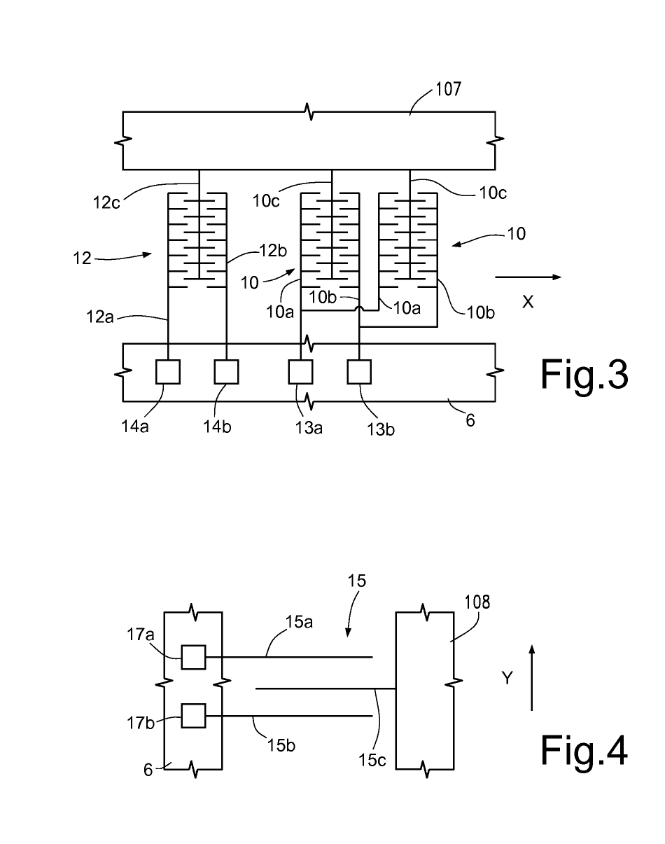

As illustrated in FIG. 3, according to one embodiment, the driving mass 107 is capacitively coupled to the fixed structure 6 by means of driving units 10 and feedback sensing units 12. The capacitive coupling is, for example, of a differential type.

In greater detail, the driving units 10 comprise first and second fixed driving electrodes 10a, 10b, which are anchored to the fixed structure 6 and extend substantially perpendicular to the driving direction X, and mobile driving electrodes 10c, which are anchored to the driving mass 107 and are also substantially perpendicular to the driving direction X. The mobile driving electrodes 10c are comb-fingered and capacitively coupled to respective first fixed driving electrodes 10a and second fixed driving electrodes 10b. Furthermore, the first and second fixed driving electrodes 10a, 10b of the driving units 10 are electrically connected, respectively, to a first driving terminal 13a and a second driving terminal 13b of the microstructure 102. As has been mentioned, moreover, the coupling is of a differential type. In other words, in each driving unit 10 a movement of the driving mass 107 along the driving axis X determines the increase in capacitance between the mobile driving electrode 10c and one of the fixed driving electrodes 10a, 10b. The capacitance between the mobile driving electrode 10c and the other of the fixed driving electrodes 10a, 10b decreases, instead, accordingly.

The structure of the feedback sensing units 12 is similar to that of the driving units 10. In particular, the feedback sensing units 12 comprise first and second fixed sensing electrodes 12a, 12b, anchored to the fixed structure 6, and mobile sensing electrodes 12c, which are anchored to the driving mass 107 and are comb-fingered and capacitively coupled to respective first fixed sensing electrodes 12a and second fixed sensing electrodes 12b. Furthermore, the first and second fixed sensing electrodes 12a, 12b of the feedback sensing units 12 are electrically connected, respectively, to a first feedback sensing terminal 14a and to a second feedback sensing terminal 14b of the microstructure 102.

In practice, hence, the driving mass 107 is coupled to the driving terminals 13a, 13b through differential driving capacitances C_{D1}, C_{D2} and to the sensing terminals 14a, 14b through differential feedback sensing capacitances C_{FBS1}, C_{FBS2}.

The sensing mass 108 is electrically connected to the driving mass 107, without interposition of insulating structures. Consequently, the sensing mass 108 and the driving mass 107 are at the same potential. The sensing mass 108 is moreover capacitively coupled to the fixed structure 6 by means of signal sensing units 15, as illustrated more clearly in FIG. 4. More precisely, the signal sensing units 15 comprise third and fourth fixed sensing electrodes 15a, 15b, anchored to the fixed structure 6, and mobile sensing electrodes 15c, which are anchored to the sensing mass 108 and are set between respective third fixed sensing electrodes 15a and fourth fixed sensing electrodes 15b. Also in this case, the capacitive coupling is of a differential type, but is obtained by means of electrodes with parallel plates, perpendicular to the sensing direction Y. Furthermore, the third and fourth fixed sensing electrodes 15a, 15b of the signal sensing units 15 are electrically connected, respectively, to a first signal sensing terminal 17a and to a second signal sensing terminal 17b of the microstructure 102. In practice, the sensing mass 108 is coupled to the signal sensing terminals 17a, 17b through signal sensing differential capacitances C_{SS1}, C_{SS2}.

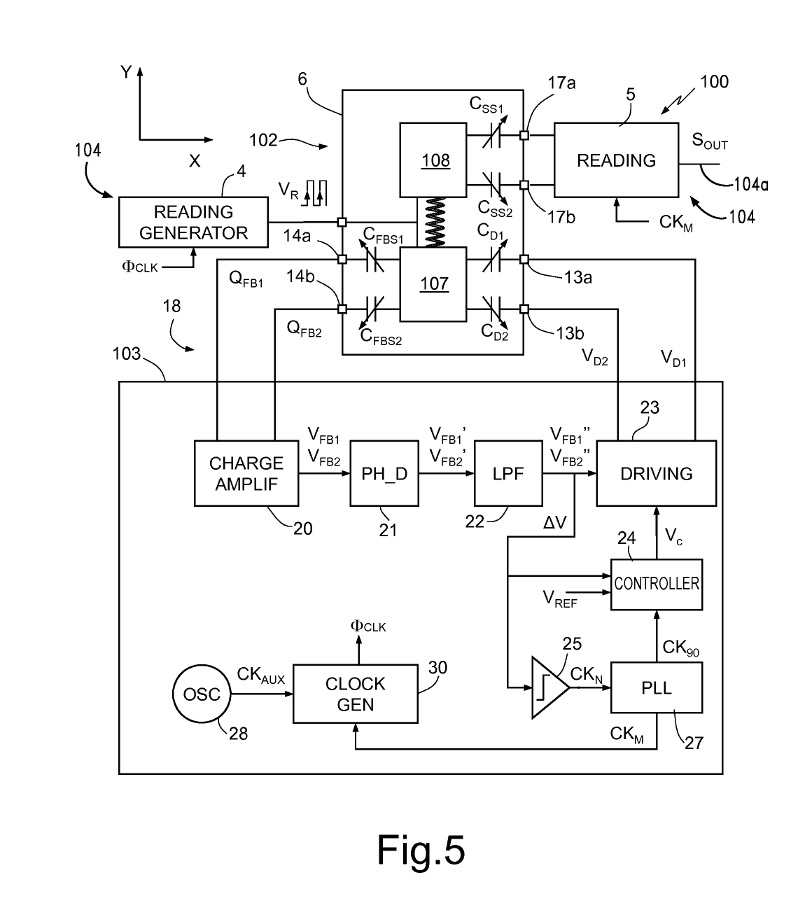

FIG. 5 shows an embodiment of the gyroscope 100. The driving device 103 is connected to the driving terminals 13a, 13b and to the feedback sensing terminals 14a, 14b of the microstructure 102 so as to form, with the driving mass 107, a microelectromechanical oscillating loop 18, with control of position of the driving mass 107. The driving device 103 does not form the subject of the present disclosure, and can be of a type different from what has been described herein. The driving device 103 comprises a charge amplifier 20, a first phase-shifter module 21, a lowpass filter 22, a driving stage 23, a controller 24, a comparator 25, and a phase-locked-loop (PLL) circuit 27.

Furthermore, an oscillator 28 and a clock generator 30, controlled by the PLL circuit 27, are used for supplying clock signals for the driving device 103 itself, as well as for the reading device 104. The reading device 104 comprises, more in particular, a reading generator 4 and a reading circuit 5 (the latter being described in greater detail hereinafter).

The reading device 104 has an output 104a, which supplies an output signal S_{OUT}. In particular, the output signal S_{OUT} is correlated to the acceleration to which the sensing mass 108 is subjected along the second axis Y and indicates the angular velocity Ω of the microstructure 102; i.e., it indicates a position of the sensing mass 108. The reading device 104 reads the displacements of the sensing mass 108, which are determined by the resultant of the forces acting on the sensing mass 108 itself along the second axis Y.

According to one embodiment, the driving device 103 exploits the loop to keep the driving mass 107 in self-oscillation along the first axis X at its resonance pulsation (0R. Furthermore, the driving device 103 generates a first clock signal CK_{M} and a second clock signal CK₉₀, phase-shifted by 90° with respect to the first clock signal CK_{M}, and supplies at least one of them, or a clock signal correlated to one of them according to a known relation, to the reading device 104, so as to synchronize the operations of driving and reading of the microstructure 102. The gyroscope 100 hence operates on the basis of a known and shared synchronism. The gyroscope 100 operates in the way described in what follows. The driving mass 107 is set in oscillation along the first axis X and drags in motion in the same direction also the sensing mass 108. Consequently, when the microstructure 102 turns about an axis perpendicular to the plane of the axes X, Y with a certain instantaneous angular velocity, the sensing mass 108 is subject to a Coriolis force, which is parallel to the second axis Y and is proportional to the instantaneous angular velocity of the microstructure 102 and to the linear velocity of the two masses 107, 108 along the first axis X. More precisely, the Coriolis force (F_{C}) is given by the equation

F_{C}=−2M_{S}ΩX′

where M_{S} is the value of the sensing mass 108, Ω is the angular velocity of the microstructure 102, and X′ is the linear velocity of the two masses 107, 108 along the first axis X.

In practice, also the driving mass 107 is subject to a Coriolis force; however, said force is substantially countered by constraints that impose on the driving mass 107 movement exclusively along the first axis X.

The Coriolis force and acceleration to which the sensing mass 108 is subjected are detected. The signal thus detected can, however, comprise also a component due to spurious drag motions, which do not correspond to actual rotations of the microstructure 102 and are due to imperfections of the constraints of the driving mass 107 or else of the mechanical coupling to the sensing mass 108.

In particular, the output signal S_{OUT} comprises a component correlated to the Coriolis force (and acceleration) and hence also to the instantaneous angular velocity of the microstructure 102, and a component correlated to the spurious drag motions. Furthermore, the output signal S_{OUT} is a signal amplitude-modulated in a way proportional to the Coriolis force and, consequently, to the instantaneous angular velocity of the microstructure 102. The output signal is, in particular, a suppressed-carrier signal of a DSB-SC (Double Side Band-Suppressed Carrier) type. The band of pulsations associated to the modulating quantity, i.e., the instantaneous angular velocity, is much lower than the resonance pulsation ω_{R} (some orders of magnitude less). The resonance pulsation ω_{R} is, for example, comprised between 1 kHz and 30 kHz, whilst the band of pulsations associated to the modulating quantity is, for example, comprised between 1 Hz and 300 Hz. Said values are purely indicative of possible non-limiting embodiments.

Operation of the driving device 103 is briefly described with reference to FIG. 5. The charge amplifier 20 defines a detection interface for detection of the position x of the driving mass 107 with respect to the driving axis X. The remaining components of the driving device 103 co-operate for controlling, on the basis of the position x of the driving mass 107, the amplitude of oscillation of the microelectromechanical loop 18, in particular the amplitude of oscillation of the driving mass 107, and keeping it close to a reference amplitude. The reference amplitude is, in particular, determined by means of a reference voltage V_{REF}, which is supplied to the controller 24.

The charge amplifier 20 has inputs respectively connected to the first feedback sensing terminal 14a and to the second feedback sensing terminal 14b and defines a detection interface for detection of the position x of the driving mass 107 with respect to the driving axis X. The charge amplifier 20 receives differential charge packets QFB1, QFB2 from the feedback sensing terminals 14a, 14b of the microstructure 102 and converts them into feedback voltages V_{FB1}, V_{FB2}, which indicate the position x of the driving mass 107. In this way, the charge amplifier 20 performs a discrete-time reading of the position x of the driving mass 107.

The phase-shifter module 21 and the lowpass filter 22 carry out a conditioning of the feedback voltages V_{FB1}, V_{FB2}.

In greater detail, the phase-shifter module 21 is connected in cascaded mode to the charge amplifier 20 and introduces a phase shift as close as possible to 90° and in any case is comprised in the interval 90°±40°. In one embodiment, the phase-shifter module 21 comprises a sample-and-hold circuit and is moreover configured so as to carry out a first filtering of a lowpass type. Phase-shifted feedback voltages V_{FB1}′, V_{FB2}′ supplied by the phase-shifter module 21 are hence delayed and attenuated with respect to the feedback voltages V_{FB1}, V_{FB2}.

The lowpass filter 22 is set downstream of the phase-shifter module 21, is a fully differential second-order filter, and supplies filtered feedback voltages V_{FB1}″, V_{FB2}″ that are variable with continuity over time. The cutoff frequency of the lowpass filter 22 is selected in such a way that the frequency of oscillation of the microelectromechanical loop 18 (i.e., the driving frequency ω_{D} of the driving mass 107) is included in the passband and in such a way that the phase of the useful signal indicating the position x of the driving mass 107 is not substantially altered. Furthermore, the passband of the lowpass filter 22 is such that the undesired signal components, linked to the sampling by means of discrete-time reading, will be attenuated by at least 30 dB.

In order to prevent offsets that could jeopardize control of the oscillations of the microelectromechanical loop 18, both the phase-shifter module 21, and the lowpass filter 22 are based upon amplifiers provided with autozero function.

The driving stage 23 is of a continuous-time fully differential type and has variable gain. Furthermore, the driving stage 23 is set cascaded to the lowpass filter 22 and has outputs connected to the driving terminals 13a, 13b of the microstructure 102, for supplying driving voltages V_{D1}, V_{D2} such as to sustain oscillation of the microelectromechanical loop 18 at the driving frequency ω_{D}, which is close to the mechanical resonance frequency ω_{R} of the microstructure 102. For this purpose, the gain G of the driving stage 23 is determined by the controller 24 by means of a control signal V_{C} correlated to the filtered feedback voltages V_{FB1}″, V_{FB2}″ supplied by the lowpass filter 22. The controller 24 is, for example, a discrete-time PID controller. In particular, the gain G is determined so as to keep the conditions of oscillation of the microelectromechanical loop 18 (unit loop gain and phase shift that is an integer multiple of 360°). For this purpose, the controller 24 receives at input the reference voltage V_{REF}, which indicates the desired reference oscillation amplitude. Furthermore, the driving stage 23 is configured for reversing the sign of the alternating differential components (AC components) of the driving voltages V_{D1}, V_{D2} at each CDS cycle during the reading step. In greater detail, the driving voltages V_{D1}, V_{D2} are respectively given by

V_{D1}=V_{CM}+K₀ sin ω_{A}t

V_{D2}=V_{CM}−K₀ sin ω_{A}t

In the above equations, V_{CM} is a common-mode voltage of the driving stage 23, K₀ is a constant, and ω_{A} is the current oscillation frequency of the microelectromechanical loop 18 (close to the driving frequency ω_{D} in steady-state conditions). The differential components of the driving voltages V_{D1}, V_{D2} are defined by the terms K₀ sin ω_{A}t. The second fraction of the cycle starts simultaneously with the sensing step and terminates slightly in advance.

The comparator 25 has inputs connected to the inputs of the driving stage 23, which define control nodes 25a, and receives the voltage difference ΔV between the feedback voltages V_{FB1}″, V_{FB2}″ filtered by the lowpass filter 22. The comparator 25 switches at each zero-crossing of the voltage difference ΔV, thus operating as a frequency-detection device. In one embodiment, the comparator 25 is connected to just one control node and switches at each zero-crossing of one between the filtered feedback voltages V_{FB1}″, V_{FB2}″ (the zero-crossings of the filtered feedback voltages V_{FB1}″, V_{FB2}″ and of the voltage difference ΔV coincide).

The output of the comparator 25, which supplies a native clock signal CK_{N}, is connected to an input of the PLL circuit 27 so as to enable phase locking with the microelectromechanical loop 18. The native clock signal CK_{N} is, however, phase-shifted with respect to the driving mass on account of the presence of the charge amplifier 20, the first phase-shifter module 21, and the lowpass filter 22.

The PLL circuit 27 supplies a master clock signal CK_{M} and a quadrature clock signal CK₉₀. The master clock signal CK_{M} has a frequency equal to an integer multiple of the frequency of the native clock signal CK_{N}. If we denote by ω_{M} the frequency of the master clock signal CK_{M} and by ω_{N} the frequency of the native clock signal CK_{N}, we hence have ω_{M}=Kω_{N}, for example with K=2¹⁰. The variable K can, however, assume different values, including unit value.

The quadrature clock signal CK₉₀ has the same frequency as and is phase-shifted by 90° with respect to the native clock signal CK_{N} and is used for timing the controller 24. In practice, the quadrature clock signal CK₉₀ switches at the maxima and at the minima of the filtered feedback voltages V_{FB1}″, V_{FB2}″ at output from the lowpass filter 22. The controller 24 is thus correctly timed so as to sample the peak values of the voltage difference ΔV between the filtered feedback voltages V_{FB1}″, V_{FB2}″.

The oscillator 28 supplies to the clock generator 30 an auxiliary clock signal CK_{AUX} having a calibrated frequency, close to the main frequency ω_{M}.

The clock generator 30 receives the master clock signal CK_{M} and the auxiliary clock signal CK_{AUX} and uses them for generating the clock signals necessary for the discrete-time components and, more in general, for proper operation of the gyroscope 100. The auxiliary clock signal is used when the PLL circuit 27 is not synchronized with the oscillations of the microelectromechanical loop 18 and hence the master clock signal CK_{M} is not available, such as for example during steps of start-up or steps of recovery following upon impact. The master clock signal CK_{M} is used when the oscillations of the microelectromechanical loop 18 are stabilized at the driving frequency ω_{D}.

In detail, the clock generator 30 supplies a clock signal Φ_{CLK}, which, in steady-state conditions, has a frequency equal to an integer multiple of the frequency of the native clock signal CK_{N}, for example equal to the frequency of the master clock signal CK_{M}.

The clock signal Φ_{CLK} is used for driving the reading generator 4 so as to supply to the driving mass 107 and the sensing mass 108 a square-wave reading signal V_{R} of a duration equal to the duration of the sensing step.

The reading circuit 5 is configured for detecting a position y of the sensing mass along the sensing axis Y. In particular, the reading circuit 5 has an output supplying the output signal S_{OUT}.

In use, the driving mass 107 is set in oscillation along the driving axis X by the driving device 103 at the driving frequency ω_{D} in steady-state conditions. The sensing mass 108 is dragged in motion along the driving axis X by the driving mass 107. Consequently, when the microstructure 102 turns about a gyroscopic axis perpendicular to the plane of the axes X, Y with a certain instantaneous angular velocity Ω, the sensing mass 108 is subjected to a Coriolis force, which is parallel to the sensing axis Y and is proportional to the angular velocity Ω of the microstructure 102 and to the velocity of the two masses 107, 108 along the driving axis X.

The displacements of the sensing mass 108 caused by the Coriolis force are read by applying the reading signal V_{R} to the sensing mass 108 itself and generating, on the basis of the differential charge packets thus produced, the output signal S_{OUT}. The controller 24, the comparator 25, and the PLL circuit 27 co-operate with the phase-shifter module 21, the lowpass filter 22, and the driving stage 23 for creating and maintaining the conditions of oscillation of the microelectromechanical loop 18 in different steps of operation of the gyroscope 100. In particular, the driving stage 23 applies to the driving mass 107 electrostatic forces such as to favor oscillations thereof at each instant.

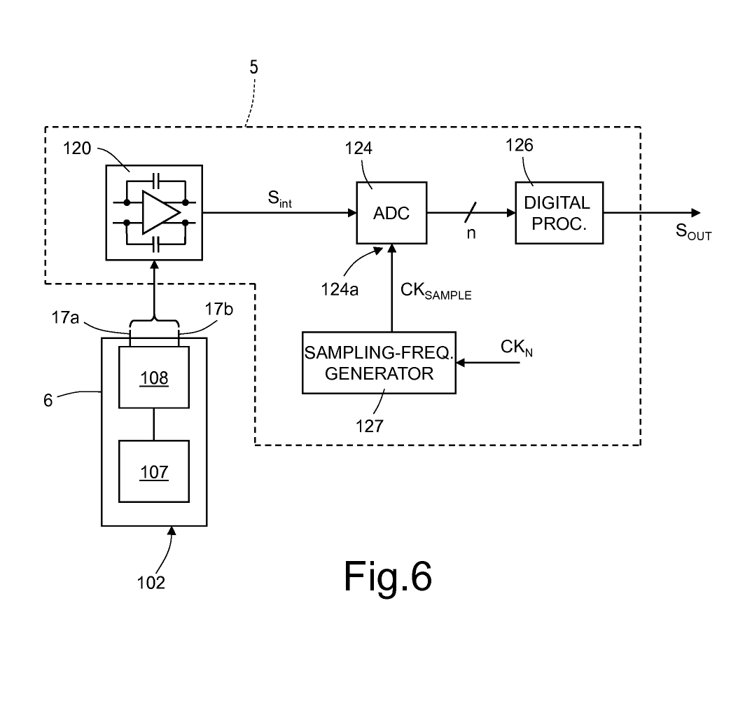

An embodiment of the reading circuit 5 is illustrated in detail in FIG. 6, and described with reference to said figure.

With reference to FIG. 6, a reading device 5 comprises a charge amplifier 120, an analog-to-digital converter 124, a digital processor 126, and a sampling-frequency generator 127.

The charge amplifier 120 has inputs connected to the terminals 17a, 17b of the sensing mass 108 for receiving reading signals in current that are correlated to the linear velocity of oscillation of the sensing mass 108 along the second axis Y. On account of the charge amplification, on the outputs of the charge amplifier 120 reading voltages are present indicating the displacement of the sensing mass 108 along the second axis Y.

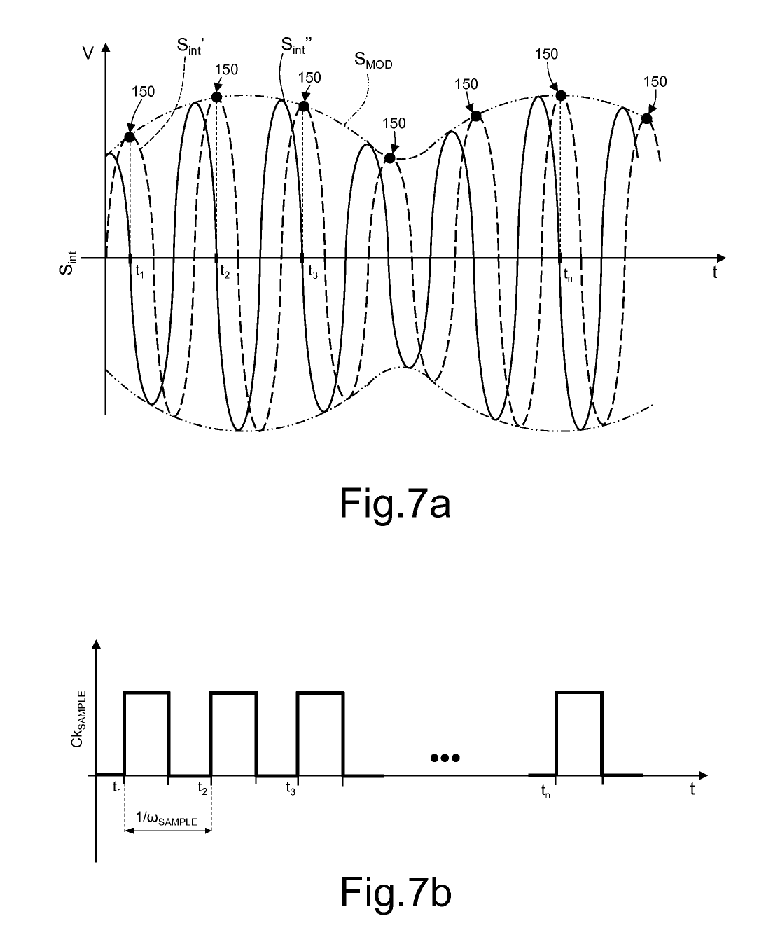

In particular, an output from the charge amplifier 120 an intermediate signal Sᵢₙₜ is present, for example of the type illustrated schematically in FIG. 7a, which is correlated both to the instantaneous angular velocity of the microstructure 102 and to the spurious drag motions.

The analog-to-digital converter 124 is connected to the charge amplifier 120, downstream of the latter, and receives at input the intermediate signal Sᵢₙₜ. The analog-to-digital converter 124 moreover has a conversion input 124a connected to the sampling-frequency generator 127 for receiving a clock signal CK_{SAMPLE} with a frequency ω_{SAMPLE}. The output of the analog-to-digital converter 124 is a quantized digital signal and comprises numerical words on n bits (with n chosen according to the digital processor 126 used and according to the precision required). Said numerical words are supplied to the digital processor 126 for subsequent processing steps (which are optional and do not form part of the present disclosure).

The intermediate signal Sᵢₙₜ is amplitude modulated in DSB-SC mode and is the sum of two components. A first component, useful for measuring the instantaneous angular velocity, is in phase with the displacement of the sensing mass 108 and has an amplitude correlated to the Coriolis force (acceleration), along the second axis Y, to which the sensing mass 108 itself is subject as a result of the oscillation along the first axis X and of the rotation of the microstructure 102. A second component, phase-shifted by 90°, is correlated to the spurious drag motions. For instance, if the driving mass 107 oscillates in a direction not perfectly aligned to the first axis X, the sensing mass 108 can be dragged in oscillation along the second axis Y even in the absence of rotation of the microstructure 102.

Both of the contributions have the same carrier frequency, i.e., the resonance frequency ω_{R} of the driving mass 107, but are phase-shifted with respect to one another by 90°. For instance, the first contribution is in phase with the clock signal CK_{N}, whereas the second contribution is in phase with the clock signal CK₉₀.

FIG. 7a shows the intermediate signal Sᵢₙₜ, which is amplitude-modulated and is divided into its first and second components Sᵢₙₜ′, Sᵢₙₜ″. As may be noted, the first and second components Sᵢₙₜ′, Sᵢₙₜ″ are phase-shifted with respect to one another by 90°, so that when the first component Sᵢₙₜ′ (useful contribution) reaches a maximum value, the second component Sᵢₙₜ″ (contribution correlated to the spurious drag motions and hence not useful) assumes a zero value. The signal S_{MOD} (indicated by a dashed line) is the upper envelope and represents the modulating signal.

The first component Sᵢₙₜ′ of the intermediate signal Sᵢₙₜ has a known frequency, and in particular is equal to the driving frequency ω_{D}, which is close to the resonance frequency ω_{R}. Also the second component Sᵢₙₜ″ of the intermediate signal Sᵢₙₜ has a frequency equal to the resonance frequency ω_{R}. Consequently, the period of the first and second components Sᵢₙₜ′, Sᵢₙₜ″ is equal to 1/ω_{R}. The analog-to-digital converter 124 is configured in such a way as to perform a sampling of the intermediate signal Sᵢₙₜ at the instants t₁, t₂, t₃, . . . , tₙ, where each of said instants t₁-tₙ is equal to a multiple of the basic period 1/ω_{R}. In this way, each sample (designated by way of example in FIG. 7a by the reference number 150) is exclusively indicative of the useful information of the intermediate signal Sᵢₙₜ, and does not carry information on the second component Sᵢₙₜ″ (since, as may be noted from the figure, the second component Sᵢₙₜ″ at the instants t₁-tₙ is approximately equal to zero).

The sampling instants are defined by the clock signal CK_{SAMPLE}, represented in FIG. 7b using the same time scale as that used in FIG. 7a. The period of the clock signal CK_{SAMPLE} is equal to 1/ω_{R} where, as has been said, ω_{R} is the resonance frequency, which is known since the system operates with a known synchronism. The phase of the clock signal CK_{SAMPLE} is given by the phase of the main clock signal CK_{M}. Accordingly, the analog-to-digital converter 124 is configured to sample the intermediate signal Sᵢₙₜ at a frequency equal to a multiple or submultiple of the resonance frequency (about equal to the driving frequency according to an aspect of the present disclosure) and with a phase equal to the phase of the main clock signal CK_{M}. In this way, the intermediate signal Sᵢₙₜ can be sampled at maximum values of the first signal component Sᵢₙₜ′.

In general, if the gyroscope 100 does not operate at the resonance frequency, the step of analog-to-digital conversion occurs at a frequency ω_{SAMPLE} (i.e., with a period defined by the clock signal CK_{SAMPLE} equal to 1/ω_{SAMPLE}), which is equal to the frequency ω_{D} of the driving signal (equal to the frequency of the clock signal CK_{N}, or equal to a multiple or submultiple of the frequency of the clock signal CK_{N}).

Since, in practice, the frequency of the modulating signal S_{MOD} is of one or more orders of magnitude lower than the frequency of the signal Sᵢₙₜ′, the sampling theorem is always respected.

The reading device 104 is advantageous because it enables precise reading of the displacements of the sensing mass 108 using only circuits of a digital type, in particular eliminating the need for a plurality of analog blocks cascaded to one another for detecting the useful signal.

For this reason, the reading device 104 is much simpler to obtain as compared to reading devices of a known type.

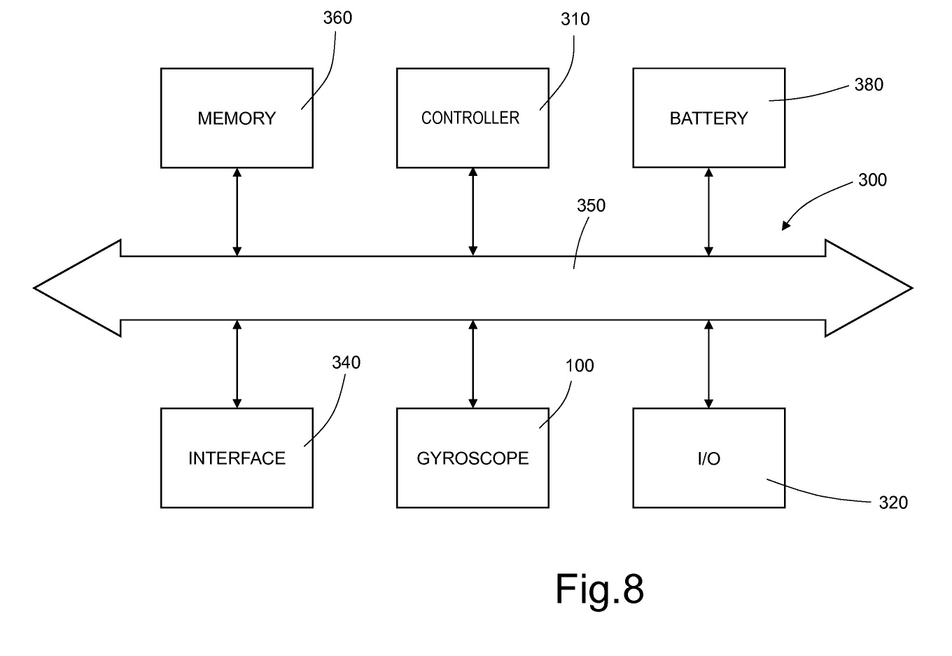

Illustrated in FIG. 8 is a portion of an electronic system 300 in accordance with one embodiment of the present disclosure. The system 300 incorporates the gyroscope 100 and can be used in devices such as, for example, a palmtop computer (personal digital assistant, PDA), a laptop or portable computer, possibly with wireless capacity, a cell phone, a messaging device, a digital music player, a digital camera, or other devices designed to process, store, transmit, or receive information. For instance, the gyroscope 100 can be used in a digital camera for detection of movements and carry out an image stabilization. In other embodiments, the gyroscope 100 is included in a portable computer, a PDA, or a cell phone for detection of a free-fall condition and activation of a safety configuration. In a further embodiment, the gyroscope 100 is included in a user interface activated by movement for computers or consoles for videogames. In a further embodiment, the gyroscope 100 is incorporated in a satellite navigation device and is used for temporary position tracking in the event of loss of the satellite positioning signal.

The electronic system 300 can comprise, in addition to the gyroscope 100, a controller 310, an input/output (I/O) device 320 (for example, a keyboard or a screen), a wireless interface 340 and a memory 360 of a volatile or nonvolatile type, coupled together through a bus 350. In one embodiment, a battery 380 can be used to supply the system 300. It is to be noted that the scope of the present disclosure is not limited to embodiments having necessarily one or all of the devices listed.

The controller 310 can comprise, for example, one or more microprocessors, microcontrollers, and the like.

The I/O device 320 can be used for generating a message. The system 300 can use the wireless interface 340 for transmitting and receiving messages to and from a wireless communication network with a radiofrequency (RF) signal. Examples of wireless interface can comprise an antenna, a wireless transceiver, such as a dipole antenna, although the scope of the present disclosure is not limited from this standpoint. Furthermore, the I/O device 320 can supply a voltage representing what is stored either in the form of a digital output (if digital information has been stored) or in the form of analog information (if analog information has been stored).

Finally, it is evident that modifications and variations may be made to the resonant microelectromechanical system described herein, without thereby departing from the scope of the present disclosure.

For instance, the reading device 104 can moreover comprise an anti-aliasing filter set downstream of the analog-to-digital converter 124.

Furthermore, the disclosure can advantageously be exploited to obtain electromechanical oscillators of any type, as already mentioned previously. Furthermore, the reading device according to the disclosure can be used in gyroscopes having microstructures different from the ones described. For instance, the driving mass and the sensing mass could be in direct electrical connection with one another, without insulation regions. In this case, it is, however, preferable to associate an offset-compensation stage to the transimpedance amplifier. As an alternative, it is also possible to use a single mass with driving and sensing systems for two independent axes.

Furthermore, the disclosure can advantageously be exploited in: gyroscopes with one or more sensing masses that are linearly mobile with respect to the driving mass and sensitive to rotations of pitch and/or roll (in addition to yaw); gyroscopes with cantilever sensing masses or with beams oscillating about centroidal or non-centroidal axes; and uniaxial and multiaxial gyroscopes with angularly oscillating driving mass.

Furthermore, it is clearly possible to use a different number of clock signals, with different phase relations to carry out driving of the microelectromechanical loop. In this connection, it is possible to generate the clock signals using a single master clock signal supplied by an asynchronous oscillator calibrated at the driving frequency. The PLL circuit can thus be eliminated, with considerable saving in terms of area occupation and of additional components external to the chip.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A microelectromechanical gyroscope, comprising:
a body;
a microelectromechanical control loop that includes:
a driving mass, mobile with respect to the body with a first degree of freedom according to a driving axis; and
a driving device coupled to the driving mass, the loop being configured to keep the driving mass in oscillation according to the driving axis at a driving frequency;
a sensing mass, mechanically coupled to the driving mass and configured to move according to the driving axis, the sensing mass being mobile with respect to the driving mass with a second degree of freedom according to a sensing axis, in response to rotations of the body; and
a reading device having an input that is configured to receive a sensing signal associated with the movement of the sensing mass with respect to the driving axis and the sensing axis, the reading device being configured to supply an output signal that indicates a position of the sensing mass with respect to the driving axis and the sensing axis, the reading device including:
an analog-to-digital converter having an input that is configured to receive a voltage signal associated with the sensing signal, said voltage signal having a first signal component and a spurious second signal component phase-shifted from the first signal component by approximately 90°, the analog-to-digital converter being configured to sample said voltage signal in correspondence with maximum values reached by the first signal component.

2. The microelectromechanical gyroscope according to claim 1, wherein said first signal component is correlated to the Coriolis force to which the sensing mass is subject during use, and said spurious second signal component is correlated to spurious drag motions of the sensing mass to which the sensing mass is subject during use.

3. The microelectromechanical gyroscope according to claim 1, wherein said voltage signal associated with the sensing signal is a suppressed-carrier amplitude-modulated signal, and said driving frequency has a value close to a resonance frequency of the driving mass.

4. The microelectromechanical gyroscope according to claim 1, wherein the first signal component reaches said maximum values as the spurious second signal component reaches approximately zero values, said first signal component configured to reach the maximum values with a frequency equal to the driving frequency.

5. The microelectromechanical gyroscope according to claim 1, wherein the analog-to-digital converter is configured to sample said voltage signal associated with the sensing signal at a frequency equal to a multiple or submultiple of said driving frequency.

6. The microelectromechanical gyroscope according to claim 1, wherein said driving device includes:
a differential read amplifier configured to supply first signals indicating a rate of oscillation of said driving mass;
a driving-and-control stage configured to supply second signals to drive said driving mass based on said first signals;
a controller; and
a synchronization circuit associated with the controller and configured to time said controller based on said first signals, the synchronization circuit including a comparator configured to receive input signals associated with said first signals and configured to supply at an output a first clock signal in the form of a square-wave voltage having rising edges as the first signal component reaches said maximum values.

7. The microelectromechanical gyroscope according to claim 6, further comprising a high-pass filter, connected between said differential read amplifier and said driving-and-control stage and having a passband including said driving frequency, wherein said differential read amplifier, said filter and said driving-and-control stage are connected to form an oscillating feedback loop that includes said driving mass.

8. A system, comprising:
a control unit; and
a microelectromechanical gyroscope coupled to the control unit, the gyroscope including:
a body;
a microelectromechanical control loop that includes:
a driving mass, mobile with respect to the body with a first degree of freedom according to a driving axis; and
a driving device coupled to the driving mass, the loop being configured to keep the driving mass in oscillation according to the driving axis at a driving frequency;
a sensing mass, mechanically coupled to the driving mass and configured to move according to the driving axis, the sensing mass being mobile with respect to the driving mass with a second degree of freedom according to a sensing axis, in response to rotations of the body; and
a reading device having an input that is configured to receive a sensing signal associated with the movement of the sensing mass with respect to the driving axis and the sensing axis, the reading device being configured to supply an output signal that indicates a position of the sensing mass with respect to the driving axis and the sensing axis, the reading device including:
an analog-to-digital converter having an input that is configured to receive a voltage signal associated with the sensing signal, said voltage signal having a first signal component and a spurious second signal component phase-shifted from the first signal component by approximately 90°, the analog-to-digital converter being configured to sample said voltage signal in correspondence with maximum values reached by the first signal component.

9. The system of claim 8, wherein said first signal component is correlated to the Coriolis force to which the sensing mass is subject during use, and said spurious second signal component is correlated to spurious drag motions of the sensing mass to which the sensing mass is subject during use.

10. The system of claim 8, wherein the first signal component reaches said maximum values as the spurious second signal component reaches approximately zero values, said first signal component configured to reach the maximum values with a frequency equal to the driving frequency.

11. The system of claim 8, wherein said driving device includes:
a differential read amplifier configured to supply first signals indicating a rate of oscillation of said driving mass;
a driving-and-control stage configured to supply second signals to drive said driving mass based on said first signals;
a controller; and
a synchronization circuit associated with the controller and configured to time said controller based on said first signals, the synchronization circuit including a comparator configured to receive input signals associated with said first signals and configured to supply at an output a first clock signal in the form of a square-wave voltage having rising edges as the first signal component reaches said maximum values.

12. The system of claim 11, further comprising a high-pass filter, connected between said differential read amplifier and said driving-and-control stage and having a passband including said driving frequency, wherein said differential read amplifier, said filter and said driving-and-control stage are connected to form an oscillating feedback loop that includes said driving mass.

13. A method, comprising:
driving a microelectromechanical gyroscope that includes a body and a driving mass, which is mobile with respect to the body with a first degree of freedom according to a driving axis, and a sensing mass, which is mechanically coupled to the driving mass and configured to move with the driving axis and is mobile with respect to the driving mass with a second degree of freedom according to a sensing axis, in response to rotations of the body;
oscillating the driving mass according to the driving axis at a driving frequency with a driving device;
forming a microelectromechanical control loop with the body and the driving mass;
moving the sensing mass according to the driving axis and the sensing axis;
acquiring at least one sensing signal associated with the movement of the sensing mass with respect to the driving axis and the sensing axis; and
supplying, based on the sensing signal, an output signal indicating a position of the sensing mass with respect to the driving axis and to the sensing axis;
generating a voltage signal, associated with the sensing signal, having a first signal component and a spurious second signal component that phase-shifted by approximately 90° from the first signal component; and
sampling said voltage signal associated with the sensing signal at maximum values reached by the first signal component.

14. The method according to claim 13, wherein said first signal component is correlated to the Coriolis force to which the sensing mass is subject during use, and said spurious second signal component is correlated to spurious drag motions of the sensing mass to which the sensing mass is subject during use.

15. The method according to claim 13, comprising generating a suppressed-carrier signal by amplitude modulating said voltage signal associated with the sensing signal, said driving frequency having a value equal to a resonance frequency of the driving mass.

16. The method according to claim 13, further comprising, configuring the first signal component to reach the maximum values as the spurious second signal component reaches approximately zero values, said first signal component assuming the maximum values at a frequency equal to the driving frequency.

17. The method according to claim 13, further comprising sampling said voltage signal associated with the sensing signal at a frequency equal to a multiple or submultiple of said driving frequency.

18. A microelectromechanical gyroscope, comprising:
a body;
a microelectromechanical control loop that includes:
a driving mass, mobile with respect to the body with a first degree of freedom according to a driving axis; and
a driving device coupled to the driving mass, the loop being configured to keep the driving mass in oscillation according to the driving axis at a driving frequency;
a sensing mass, mechanically coupled to the driving mass and configured to move according to the driving axis, the sensing mass being mobile with respect to the driving mass with a second degree of freedom according to a sensing axis, in response to rotations of the body; and
a reading device having an input that is configured to receive a sensing signal associated with the movement of the sensing mass with respect to the driving axis and the sensing axis, the reading device being configured to supply an output signal that indicates a position of the sensing mass with respect to the driving axis and the sensing axis, the reading device including:
an analog-to-digital converter having an input that is configured to receive a voltage signal associated with the sensing signal, said voltage signal having a first signal component and a spurious second signal component phase-shifted from the first signal component by approximately 90°, the analog-to-digital converter being configured to sample said voltage signal associated with the sensing signal at a frequency equal to a multiple or submultiple of said driving frequency.

19. The gyroscope of claim 18, wherein said first signal component is correlated to the Coriolis force to which the sensing mass is subject during use, and said spurious second signal component is correlated to spurious drag motions of the sensing mass to which the sensing mass is subject during use.

20. The gyroscope of claim 18, wherein said driving device includes:
a differential read amplifier configured to supply first signals indicating a rate of oscillation of said driving mass;
a driving-and-control stage configured to supply second signals to drive said driving mass based on said first signals;
a controller; and
a synchronization circuit associated with the controller and configured to time said controller based on said first signals, the synchronization circuit including a comparator configured to receive input signals associated with said first signals and configured to supply at an output a first clock signal in the form of a square-wave voltage having rising edges as the first signal component reaches a first value of the multiple or submultiple of said driving frequency.
